(19) United States
(12) Patent Application Publication
(10) Pub. No.: US 2016/0154721 A1
(43) Pub. Date: Jun. 2, 2016

(54) INFORMATION PROCESSING APPARATUS, INFORMATION PROCESSING SYSTEM, AND MONITORING METHOD

(71) Applicant: FUJITSU LIMITED, Kawasaki-shi (JP)

(72) Inventors: Kazuhiro Yuuki, Kawasaki (JP); SHINICHI YAMASAKI, Sagamihara (JP)

(21) Appl. No.: 14/864,030

(22) Filed: Sep. 24, 2015

(30) Foreign Application Priority Data
Dec. 1, 2014 (JP) 2014-243548

(51) Int. Cl. G06F 11/30; G06F 11/34

(52) U.S. Cl. CPC G06F 11/3034; G06F 11/3471; G06F 11/3485

(57) ABSTRACT

An information processing apparatus includes: a processor; a module; and a controller, wherein the processor is configured to transmit a first condition for detecting an abnormality of the module to the controller, and the controller is configured to: acquire a first information from the module; determine whether the first information satisfies the first condition; and transmit a second information indicating that the abnormality of the module is detected to the processor when the first information satisfies the first condition.

### CROSS-REFERENCE TO RELATED APPLICATION

This application is based upon and claims the benefit of priority from the prior Japanese Patent Application No. 2014-243548 filed on Dec. 1, 2014, the entire contents of which are incorporated herein by reference.

### FIELD

The embodiments discussed herein are related to a system monitoring technology.

### BACKGROUND

A service processor is installed in a large scale server in order to monitor and control components provided in the large scale server.

Related technologies are disclosed in, for example, Japanese Laid-Open Patent Publication No. S60-074100 (Japanese Examined Patent Application Publication No. H3-30915), Japanese Laid-Open Patent Publication No. H08-125622, Japanese Laid-Open Patent Publication No. 2012-230597, and Japanese Laid-Open Patent Publication No. 2014-016671.

### SUMMARY

According to one aspect of the embodiments, an information processing apparatus includes: a processor; a module; and a controller, wherein the processor is configured to transmit a first condition for detecting an abnormality of the module to the controller, and the controller is configured to: acquire a first information from the module; determine whether the first information satisfies the first condition; and transmit a second information indicating that the abnormality of the module is detected to the processor when the first information satisfies the first condition.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary hardware configuration of an information processing apparatus;

FIG. 2 illustrates an example of a functional block of a service processor;

FIG. 3 illustrates an example of a data structure of a buffer;

FIG. 4 illustrates an example of a structure of a command list;

FIG. 5 illustrates an example of a command set;

FIG. 6 illustrates an example of formats of a command portion and a data portion;

FIG. 7 illustrates an example of a connection form of components;

FIG. 8 illustrates an example of a format of a determination result storing area;

FIG. 9 illustrates an example of a format of a data storing area;

FIG. 10 illustrates an example of a format of an interrupt register;

FIG. 11 illustrates an example of a format of an interval register;

FIG. 12 illustrates an example of a value and a monitoring period stored in a field of “INTERVAL”;

FIG. 13 illustrates an example of a format of an execution register;

FIG. 14 illustrates an example of a monitoring process;

FIG. 15 illustrates another example of the monitoring process;

FIG. 16 illustrates another example of the monitoring process;

FIG. 17 illustrates an example of a process performed by a service processor;

FIG. 18 illustrates another example of the process performed by the service processor; and

FIG. 19 illustrates an example of a process performed by the service processor and a Maintenance Bus Controller (MBC).

### DESCRIPTION OF EMBODIMENTS

A service processor is an independent processing unit which includes, for example, a central processing unit (CPU), a memory and the like. A target component to be monitored and controlled may include, for example, a CPU, a memory, an HDD (Hard Disk Drive) or an SSD (Solid State Drive), a cooling fan, and a temperature sensor. The service processor is installed such that an abnormality occurring in the component within the server is detected and notified to a server manager.

The processing load of the CPU of the service processor increases as the number of components within the server is increased. When the processing load of the CPU in the service processor increases, a processing delay occurs and a countermeasure for coping with the abnormality occurring in the component within the server may be delayed. In a technology for monitoring an apparatus, the processing load of the CPU of the service processor may not be reduced.

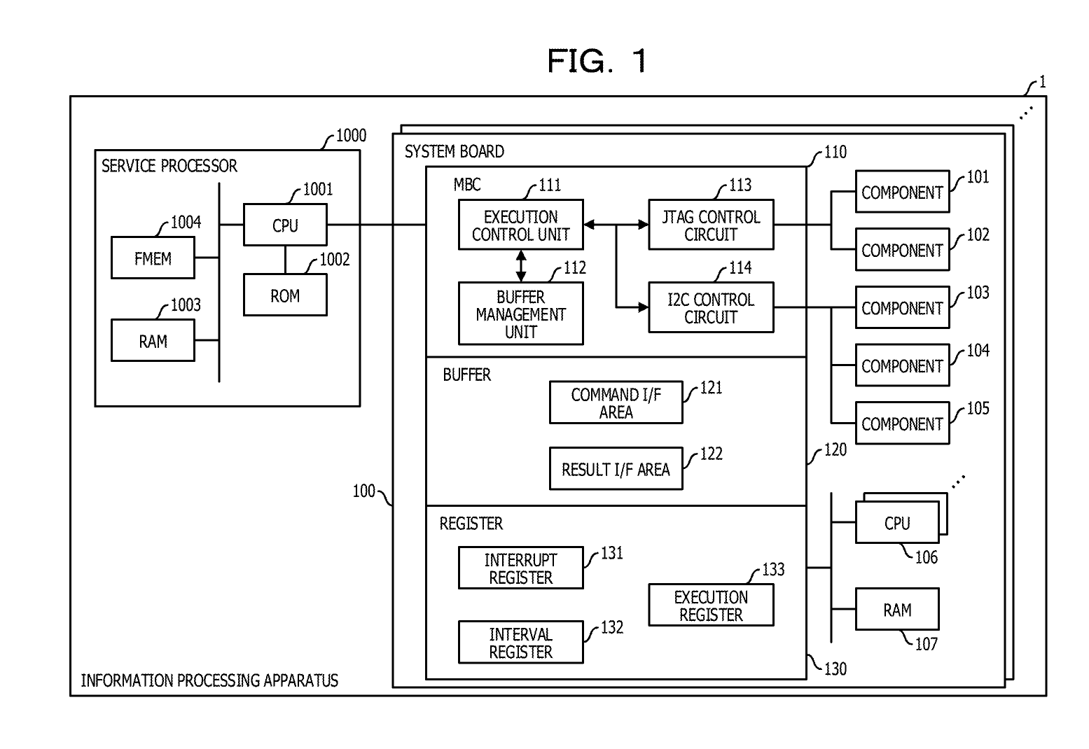

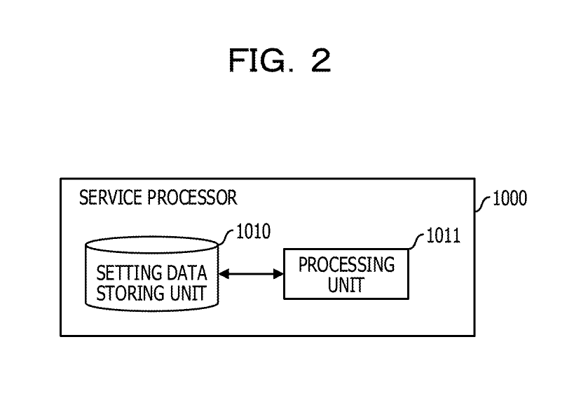

FIG. 1 illustrates an exemplary hardware configuration of an information processing apparatus. FIG. 2 illustrates an example of a functional block of a service processor. An information processing apparatus 1 includes a service processor 1000 and a single or a plurality of system boards 100.

The service processor 1000 includes a CPU 1001, a Read Only Memory (ROM) 1002, a Random Access Memory (RAM) 1003, and a Flash Memory (FMEM) 1004.

The CPU 1001 may load firmware stored in the ROM 1002 onto the RAM 1003 to execute the firmware so as to execute the function as illustrated in FIG. 2. As illustrated in FIG. 2, the service processor 1000 includes a processing unit 1011 and a setting data storing unit 1010. The setting data storing unit 1010 may be provided in the FMEM 1004. In the setting data storing unit 1010, for example, an initial value stored in a command I/F (Interface) area 121 and an initial value stored in a register 130 are stored. The processing unit 1011 executes a processing based on data stored in the setting data storing unit 1010.

The system board 100 as illustrated in FIG. 1 includes a Maintenance Bus Controller (MBC) 110, a buffer 120, a register 130, components (also referred to as modules) 101 to 105, a single CPU or a plurality of CPUs 106, and an RAM 107. The MBC 110, the buffer 120, and the register 130 may be implemented by, for example, a Field Programmable Gate Array (FPGA). The components 101 to 105 may be components, such as for example, a power supply unit, a temperature sensor, a cooling fan, and a water cooling pump. The number of components may be an arbitrary number.

The MBC 110 includes an execution control unit 111, a buffer management unit 112, a Joint Test Action Group (JTAG) control circuit 113, and an Inter-Integrated Circuit (I2C) control circuit 114. The JTAG and I2C may be used as a protocol, and other protocols may be used as well.

The execution control unit 111 executes a command set stored in a command I/F (Interface) area 121 of the buffer 120 to control the JTAG control circuit 113 and the I2C control circuit 114. The JTAG control circuit 113 acquires data from the components 101 and 102 to output the data to the execution control unit 111. The I2C control circuit 114 acquires data from the components 103 to 105 to output the data to the execution control unit 111. The buffer management unit 112 manages the buffer 120.

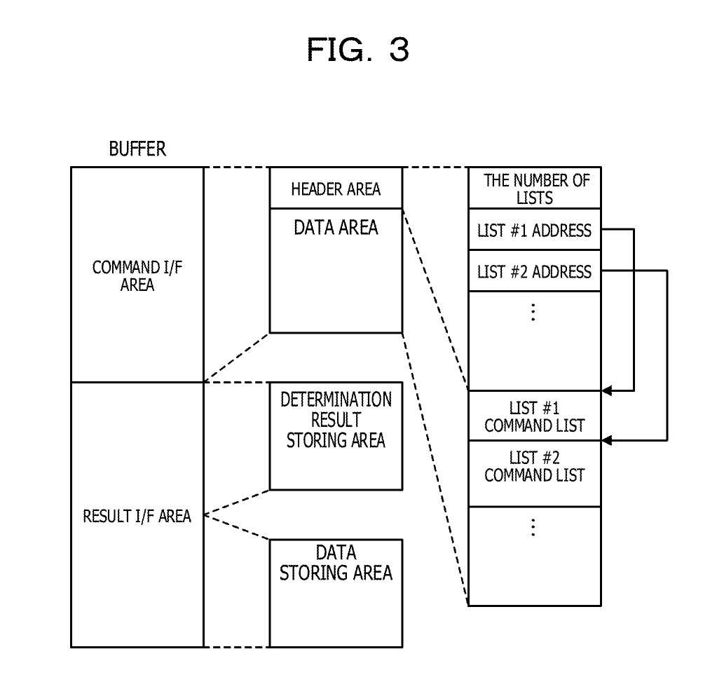

The buffer 120 includes the command I/F area 121 and a result I/F area 122. FIG. 3 illustrates an example of a data structure of a buffer. The command I/F area 121 includes a header area and a data area. The header area includes an area to store the number of lists and an area to store respective addresses of command lists. The command lists are stored in the data area. The result I/F area 122 includes a determination result storing area and a data storing area. The buffer 120 may be a storage area shared by the service processor 1000 and the MBC 110, and the service processor 1000 may access the buffer 120.

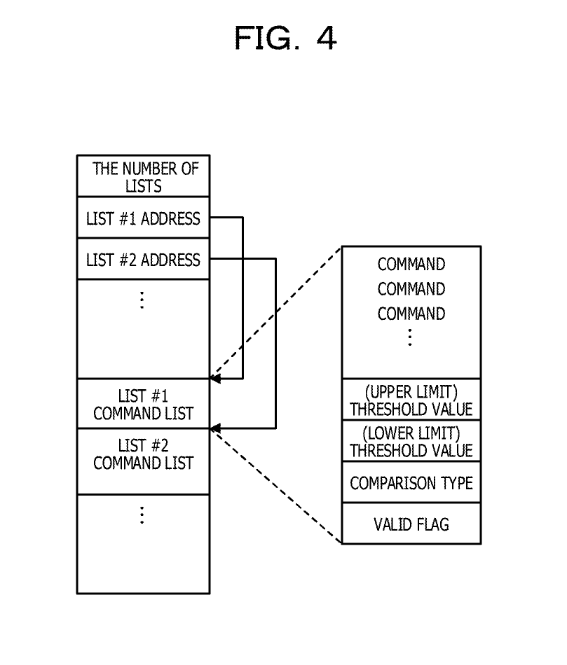

FIG. 4 illustrates an example of a structure of a command list. A single command or a plurality of commands (hereinafter, referred to as a command set), a threshold value, information indicating a comparison type, and a value of a VALID flag are stored in the command list. When the comparison type is a “range,” it is determined whether the data acquired from the component is within a range determined by the threshold value. When the comparison type is a “coincidence,” it is determined whether the data acquired from the component is coincident with the threshold value. In FIG. 4, since the comparison type is the “range,” an upper limit threshold value and a lower limit threshold value are stored in the command list, however, when the comparison type is the “coincidence,” a single threshold value is stored in the command list. When the value of the VALID flag is “ON,” a process of determining whether the abnormality is present is executed by the MBC 110, whereas when the value of the VALID flag is “OFF,” the process of determining whether the abnormality is present is not executed.

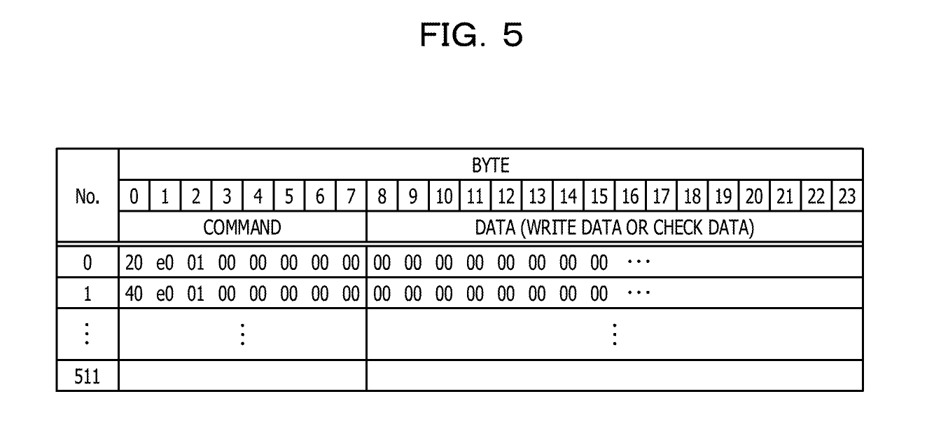

FIG. 5 illustrates an example of a command set. Each command included in the command set includes a command portion and a data portion. The data length of the command portion may be 8 bytes and the data length of the data portion may be 16 bytes. The number given to each command indicates an execution sequence.

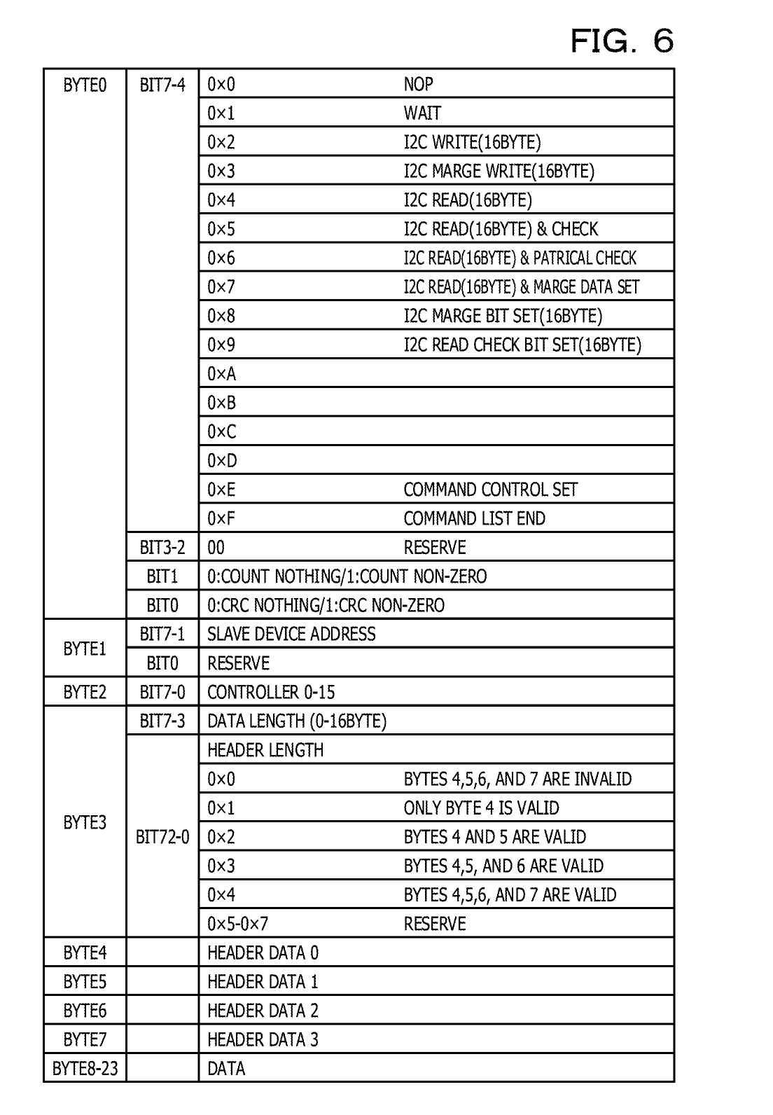

FIG. 6 illustrates an example of formats of a command portion and a data portion. In FIG. 6, the rows from “Byte 0” to “Byte 7” indicate the format of the command portion and the rows from “Byte 8” to “Byte 23” indicate the format of the data portion. As illustrated in FIG. 6, information specifying the type of processing or the like may be included in the command portion and information specifying the data to be written or the like may be included in the data portion.

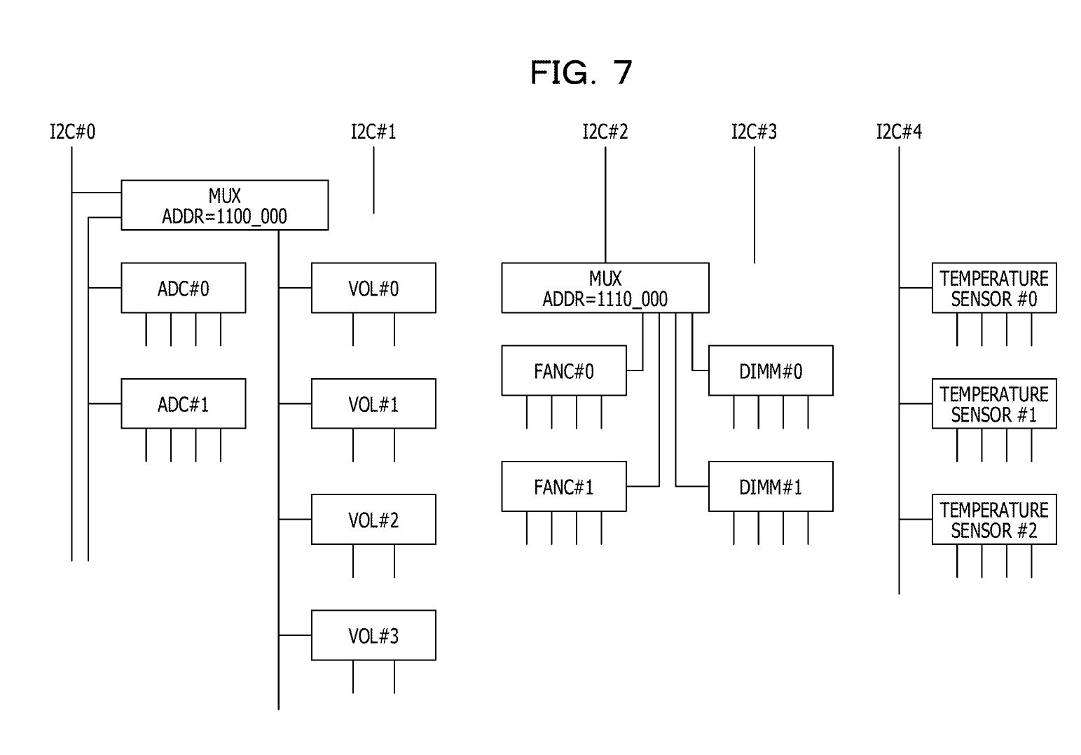

The command portion may include the designations of target components from which data are to be acquired. FIG. 7 illustrates an example of a connection form of the components. For example, when the connection form of the components is like as that illustrated in FIG. 7, a MUX (MUX indicates a multiplexer) having an address of “1100_000” is coupled to an I2C port having an identifier of I2C#0, and ADC (ADC indicates an analog digital converter) #0 and ADC #1 and VOL (VOL indicates a power supply) #0 to VOL #3 are coupled to the MUX. A MUX having an address of “1110_000” is coupled to an I2C port having an identifier of I2C#2 and FANC (FANC indicates a controller of a cooling fan) #0 and FANC #1 and DIMM (Dual Inline Memory Module) #0 and DIMM #1 are coupled to the MUX. Temperature sensors #0 to #2 are coupled to an I2C port having an identifier of I2C#4. No component is coupled to an I2C port having an identifier of I2C#1 and an I2C port having an identifier of I2C#3. In this case, when data are acquired from the FANC #0, the command portion includes, for example, an identifier of the I2C port, an address of the multiplexer, and information indicating a connection line to the FANC #0.

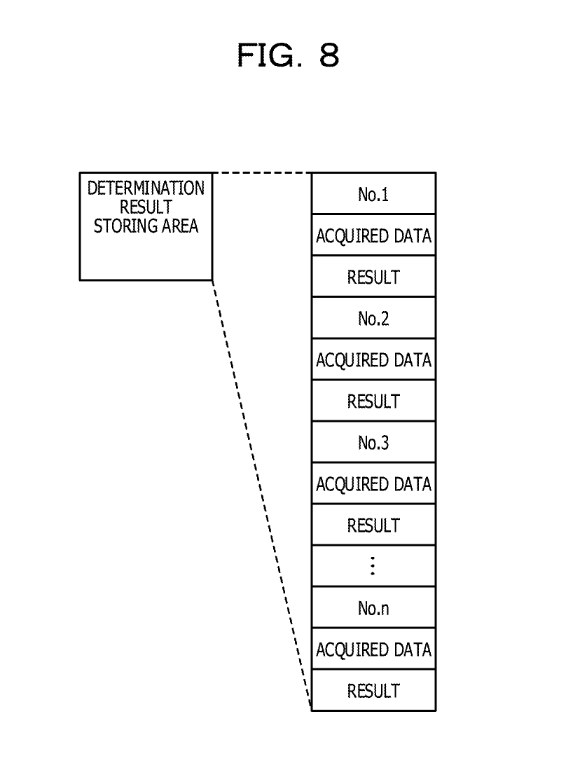

FIG. 8 illustrates an example of a format of a determination result storing area. In FIG. 8, the format of the determination result storing area in the result I/F area 122 is illustrated. The identification information of the component, data acquired from the component, and a determination result by the MBC 110 for each component are stored in the determination result storing area.

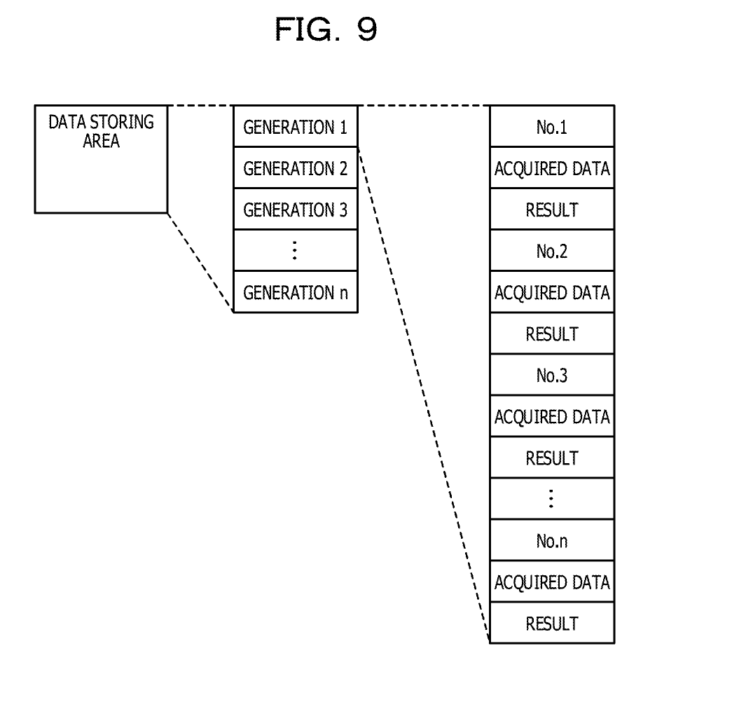

FIG. 9 illustrates an example of a format of a data storing area. In FIG. 9, the format of the data storing area in the result I/F area 122 is illustrated. The data storing area includes a sub-area which stores data relevant for generation 1, a sub-area which stores data relevant for generation 2, . . . , a sub-area which stores data relevant for generation n (n is an integer 3 or more). The data stored in each sub-area may include the identification information of the component, the data acquired from the component, and the determination result by the MBC 110 for each component. The determination results of the past are stored in the data storing area and may be used for a processing performed by the processing unit 1011.

The register 130 illustrated in FIG. 1 includes an interrupt register 131, an interval register 132, and an execution register 133.

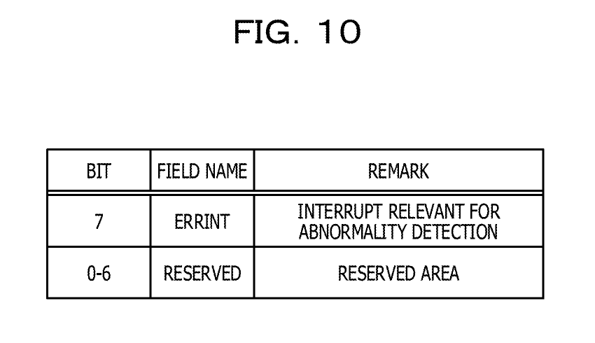

FIG. 10 illustrates an example of a format of an interrupt register. In FIG. 10, an occurrence of an interrupt relevant for an abnormality detection may be controlled by a value stored in, for example, a seventh bit, i.e., Bit 7. The area ranging from Bit 0 to Bit 6 may be a reserved area. When the value of the interrupt register 131 is “ON” (e.g., 1), an interrupt is output to the service processor 1000. When the processing for coping with an interrupt is completed, the value of the interrupt register 131 is set to “OFF” (e.g., 0).

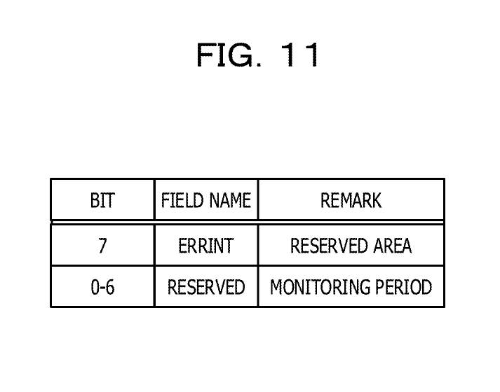

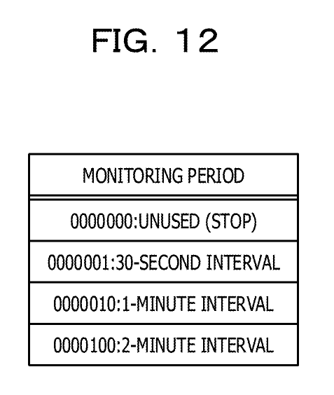

FIG. 11 illustrates an example of a format of an interval register. In FIG. 11, a monitoring period is determined by the value stored in an area ranging from Bit 0 to Bit 6. Bit 7 may be a reserved area. FIG. 12 illustrates an example of a value stored in a field of “INTERVAL” and a monitoring period. In FIG. 12, for example, when a value of “0000000” is stored in the area ranging from Bit 0 to Bit 6, monitoring is stopped, when a value of “0000001” is stored, monitoring is performed at 30 seconds intervals, when a value of “0000010” is stored, monitoring is performed at 1 minute intervals, and when a value of “0000100” is stored, monitoring is performed at 2 minutes intervals.

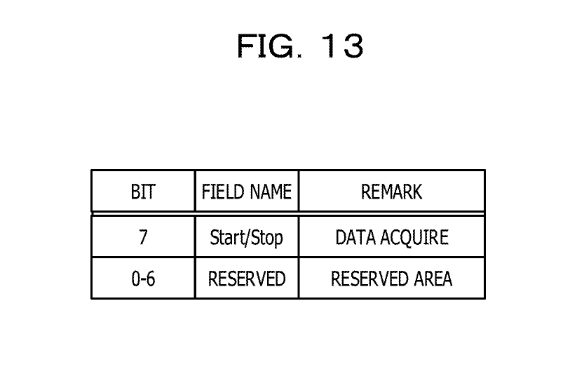

FIG. 13 illustrates an example of a format of an execution register. In FIG. 13, an execution of the monitoring may be controlled by a value stored in Bit 7. An area ranging from Bit 0 to Bit 6 may be a reserved area. When the value of Bit 7 of the execution register 133 is “ON,” for example, 1 (one), data are acquired from the components 101 to 105 and otherwise, when the value of Bit 7 of the execution register 133 is “OFF,” for example, 0 (zero), the data acquisition from the components 101 to 105 is stopped.

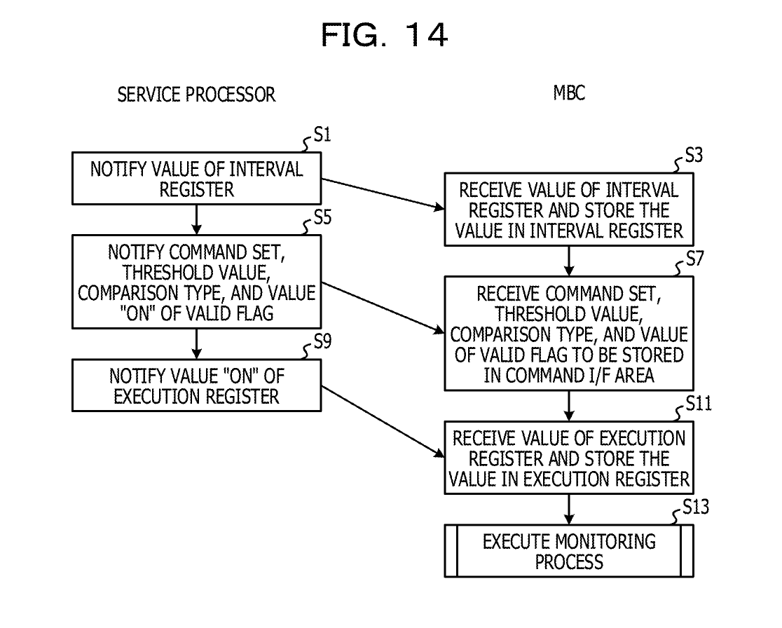

FIG. 14 to FIG. 16 illustrates an example of a monitoring process. In FIG. 14 to FIG. 16, the process executed by the service processor 1000 and the MBC 110 upon starting the monitoring of the components 101 to 105 is illustrated.

The processing unit 1011 of the service processor 1000 reads a value to be set to the interval register 132 from the setting data storing unit 1010. The processing unit 1011 notifies the MBC 110 of the system board 100 of the read value of the interval register 132 (Operation S1 of FIG. 14). Accordingly, the buffer management unit 112 of the MBC 110 receives the value of the interval register 132 from the processing unit 1011 and stores the received value in the interval register 132 (Operation S3).

The processing unit 1011 reads a command set, a threshold value, information indicating a comparison type, and a value of the VALID flag, for example, “ON,” that are relevant for each component from the setting data storing unit 1010. The processing unit 1011 notifies the MBC 110 of the system board 100 of the read command set, threshold value, information indicating the comparison type, and the value of the VALID flag (Operation S5). Accordingly, the buffer management unit 112 of the MBC 110 receives the command set, threshold value, information indicating the comparison type, and the value of VALID flag relevant for each component and stores the received ones in the command I/F area 121 (Operation S7).

The processing unit 1011 reads the value, for example, “ON” to be set to the execution register 133 from the setting data storing unit 1010. The processing unit 1011 notifies the MBC 110 of the system board 100 of the read value of the execution register 133 (Operation S9). Accordingly, the execution control unit 111 of the MBC 110 receives the value of the execution register 133 from the processing unit 1011 and stores the received value in the execution register 133 (Operation S11).

The execution control unit 111 of the MBC 110 executes a monitoring process (Operation S13).

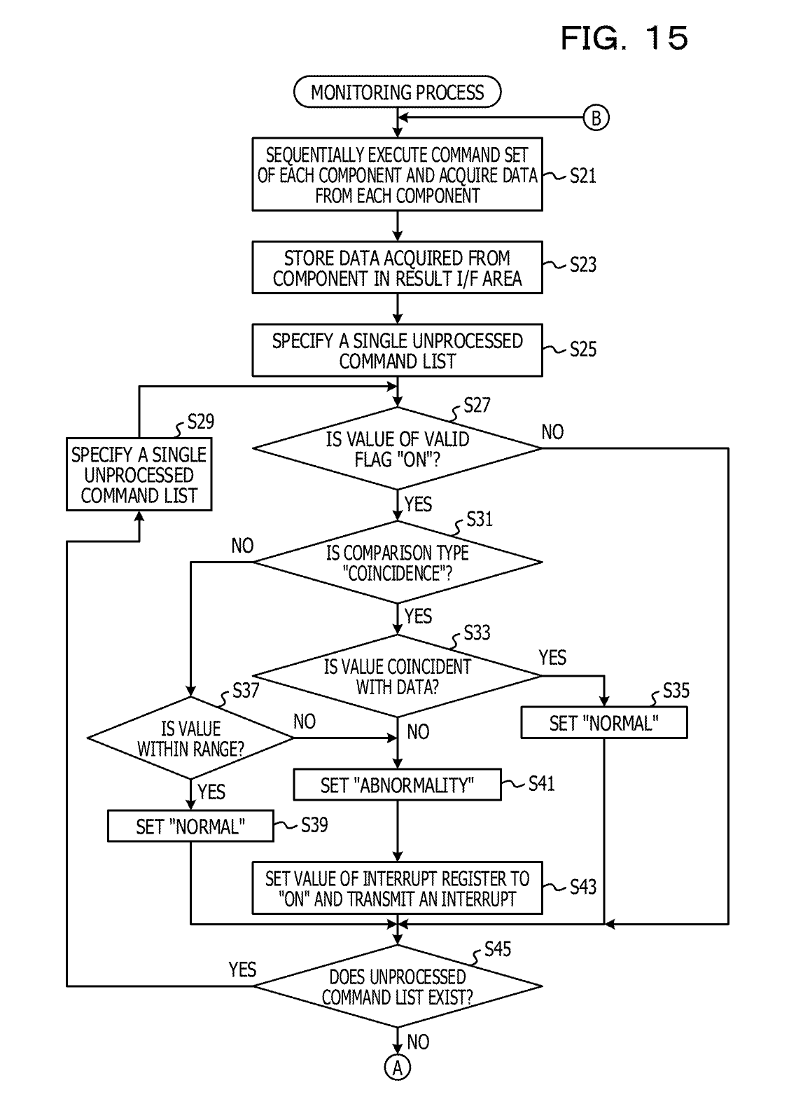

The execution control unit 111 instructs the buffer management unit 112 to read the command list relevant for the components 101 to 105. The buffer management unit 112 reads the command list relevant for the components 101 to 105 from the buffer 120 to output the command list to the execution control unit 111. The execution control unit 111 sequentially executes the command set, for example, a single command or a plurality of the commands, of each component so as to control the JTAG control circuit 113 and the I2C control circuit 114, and acquire data from each component (Operation S21 of FIG. 15). The data to be acquired may include, for example, a voltage value of a power supply, a device temperature, an outside air temperature, the number of revolutions of a cooling fan, a rotational speed of a water cooling pump and the like.

The execution control unit 111 outputs the data acquired from the components 101 to 105 to the buffer management unit 112. The buffer management unit 112 stores the data acquired from the components 101 to 105 in the result I/F area 122 (Operation S23).

The buffer management unit 112 specifies a single unprocessed command list from the command I/F area 121 (Operation S25).

The buffer management unit 112 determines whether the value of the VALID flag included in the command list specified at Operation S25 is “ON” (Operation S27).

When it is determined that the value of the VALID flag included in the command list specified at Operation S25 is not “ON” (“NO” route at Operation S27), the value of the VALID flag is “OFF.” The monitoring process proceeds to Operation S45. When it is determined that the value of the VALID flag included in the command list specified at Operation S25 is “ON” (“YES” route at Operation S27), the buffer management unit 112 determines whether the information indicating the comparison type included in the command list specified at Operation S25 indicates a “coincidence” (Operation S31).

When it is determined that the information indicating the comparison type indicates the “coincidence” (“YES” route at Operation S31), the buffer management unit 112 determines whether the threshold value included in the command list specified at Operation S25 is coincident with the data acquired from the component associated with the command list specified at Operation S25 (Operation S33).

When it is determined that the threshold value is coincident with the data acquired from the component (“YES” route at Operation S33), the buffer management unit 112 stores the determination result indicating that the abnormality is not present in the component, for example, indicating that the component is normal, in the determination result storing area of the result I/F area 122 (Operation S35). The buffer management unit 112 increments a generation for the previously stored determination result by 1 (one), deletes the data relevant for the generation n+1, and stores the determination result in the determination result storing area as the data relevant for the generation 1. The monitoring process proceeds to Operation S45.

When it is determined that the information indicating the comparison type does not indicate “coincidence” (“NO” route at Operation S31), the comparison type is a “range.” Accordingly, the buffer management unit 112 determines whether the data acquired from the component associated with the command list specified at Operation S25 is included in a range determined by the upper limit threshold value and the lower limit threshold value included in the command list specified at Operation S25 (Operation S37).

When it is determined that the data acquired from the component is included in the range determined by the upper limit threshold value and the lower limit threshold value (“YES” route at Operation S37), the buffer management unit 112 stores the determination result indicating that the abnormality is not present in the component, for example, indicating that the component is normal, in the determination result storing area of the result I/F area 122 (Operation S39). The buffer management unit 112 increments the generation of the previously stored determination result by 1 (one), deletes the data relevant for the generation n+1, and stores the determination result in the determination result storing area as the data relevant for the generation 1. The monitoring process proceeds to Operation S45.

When it is determined that the data acquired from the component is not included in the range determined by the upper limit threshold value and the lower limit threshold value (“NO” route at Operation S37) and when it is determined that the threshold value is not coincident with the data acquired from the component (“NO” route at Operation S33), the buffer management unit 112 stores the determination result indicating that the abnormality of the component is detected in the determination result storing area of the result I/F area 122 (Operation S41).

The buffer management unit 112 notifies the execution control unit 111 of the fact that the abnormality of the component is detected. Accordingly, the execution control unit 111 sets the value of the interrupt register 131 to “ON” and transmits an interrupt signal to the service processor 1000 (Operation S43).

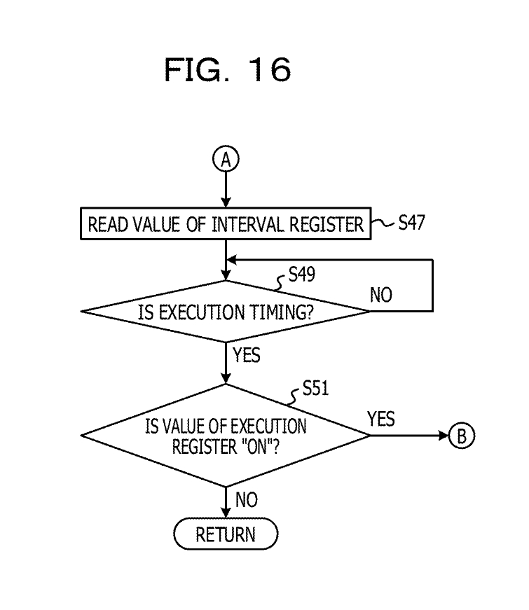

The buffer management unit 112 determines whether an unprocessed command list exists (Operation S45). When it is determined that the unprocessed command list exists (“YES” route at Operation S45), the buffer management unit 112 specifies one of the unprocessed command lists (Operation S29) and the monitoring process goes back to the processing performed at Operation S27. When it is determined that the unprocessed command list does not exist (“NO” route at Operation S45), the buffer management unit 112 sets the current time as the time at which the previous monitoring was executed, and stores the set time in the RAM 107. The monitoring process proceeds to Operation S47 of FIG. 16 through a terminal A.

As illustrated in FIG. 16, the execution control unit 111 reads the value of the interval register 132 (Operation S47). The execution control unit 111 determines whether the current time is an execution timing (Operation S49). At Operation S49, it is determined whether a time determined by the value of the interval register 132 has been elapsed from the time at which the previous monitor was executed.

When it is determined that the current time is not the execution timing (“NO” route at Operation S49), the execution control unit 111 stops a processing for a certain period of time, and the monitoring process goes back to Operation S49. When it is determined that the current time is the execution timing (“YES” route at Operation S49), the execution control unit 111 determines whether the value of the execution register 133 is “ON” (Operation S51).

When it is determined that the value of the execution register 133 is “ON” (“YES” route at Operation S51), the monitoring process goes back to Operation S21 of FIG. 15 through a terminal B in order to continue the monitoring. When it is determined that the value of the execution register 133 is not “ON” (“NO” route at Operation S51), the monitoring process goes back to the processing performed by a calling source.

The service processor 1000 collectively transmits the command lists relevant for a plurality of components to the MBC 110, and the service processor 1000 is notified of the detection of the abnormality only when the abnormality is detected by the MBC 110. Therefore, the processing load of the CPU 1001 is reduced and the occurrence of the processing delay may be decreased. Even though the number of components is increased, an increase of the processing load of the CPU 1001 may be reduced.

The MBC 110 which is hardware is suitable for a simple repetitive processing or a batch processing, but not suitable for a processing including a complex branching. Accordingly, a processing suitable for the MBC 110 is executed by the MBC 110 rather than the service processor 1000. The processing may be efficiently executed and a high-speed processing may be achieved in the entire information processing apparatus 1.

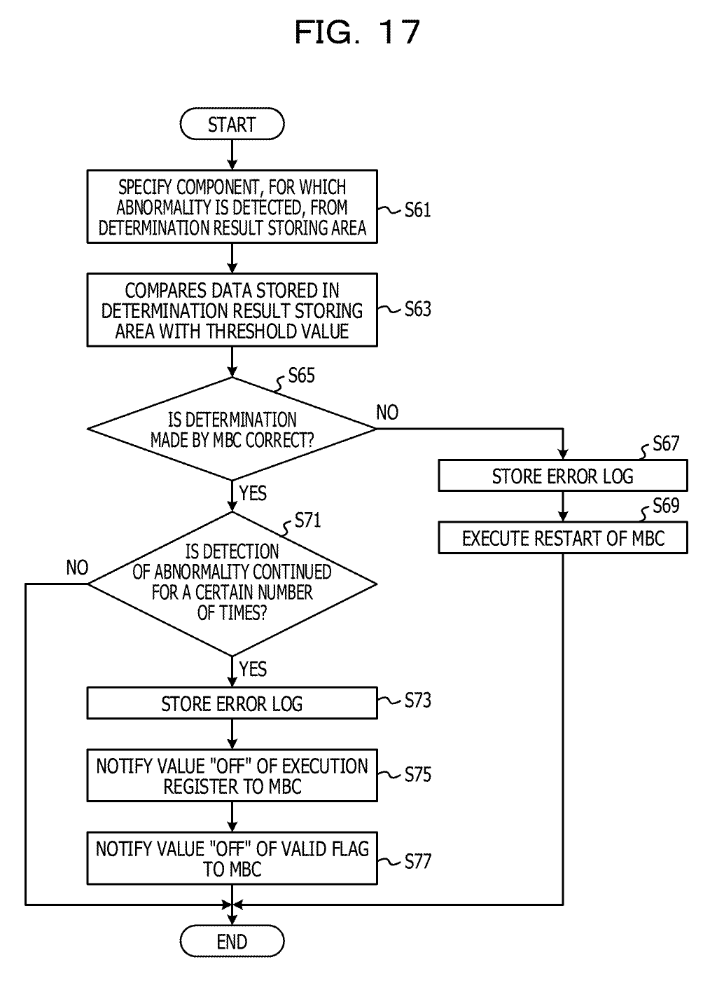

FIG. 17 illustrates an example of a process performed by a service processor. In FIG. 17, a process executed by the service processor 1000 which has received the interrupt signal is illustrated.

The processing unit 1011 of the service processor 1000 which has received the interrupt signal specifies the component, for which the abnormality is detected, from the determination result storing area (Operation S61 of FIG. 17). At Operation S61, the component, for which the information indicating that the abnormality is detected is stored in the determination result storing area, is specified.

The processing unit 1011 compares the data stored in the determination result storing area with a threshold value (Operation S63), and determines whether the determination made by the MBC 110 is correct (Operation S65). When it is determined that the determination made by the MBC 110 is not correct (“NO” route at Operation S65), the processing unit 1011 stores an error log in the FMEM 1004 (Operation S67). The error log may include, for example, information indicating that the determination made by the MBC 110 is not correct. The service processor 1000 may output the error log to, for example, a display device.

The processing unit 1011 executes a restart of the MBC 110 (Operation S69). The process performed by the service processor is ended.

When it is determined that the determination made by the MBC 110 is correct (“YES” route at Operation S65), the processing unit 1011 determines whether the detection of the abnormality is continued for a certain number of times (Operation S71). When the certain number of times is, for example, 3 (three), it is determined whether each of the determination result of the generation 1, the determination result of the generation 2, and the determination result of the generation 3 indicates that the abnormality is detected.

When it is determined that the detection of the abnormality is not continued for the certain number of times (“NO” route at Operation S71), it is estimated that the abnormality does not occur and thus, the process is ended. When it is determined that the detection of the abnormality is continued for the certain number of times (“YES” route at Operation S71), the processing unit 1011 stores the error log in the FMEM 1004 (Operation S73). The error log may include, for example, identification information of the component specified at Operation S61.

The processing unit 1011 notifies the MBC 110 of the system board 100 of the value of the execution register 133, for example, “OFF” (Operation S75). Accordingly, the buffer management unit 112 of the MBC 110 receives the value of the execution register 133 from the processing unit 1011 and stores the value in the execution register 133.

The processing unit 1011 notifies the MBC 110 of the system board 100 of the value of the VALID flag, for example, “OFF” and the identification information of the specified component (Operation S77). Accordingly, the buffer management unit 112 of the MBC 110 receives the value of the VALID flag and the identification information of the specified component from the processing unit 1011 and stores the value of the VALID flag in an area of the command I/F area 121 relevant for the specified component. The process is ended. It may be possible to reduce the retransmission of an interrupt signal for the specified component.

By the process as described above, the service processor 1000 which has received an interrupt signal may rapidly perform the countermeasure against the abnormality. Since it is confirmed whether an error exists in the determination made by the MBC 110, the performing of the countermeasure against the abnormality may be reduced even though the abnormality originally has not occurred. The data acquisition is stopped for all the components while coping with the abnormality, for example, during the maintenance of a certain component. Therefore, the acquisition of wrong data due to the performing of a countermeasure against the abnormality may be reduced.

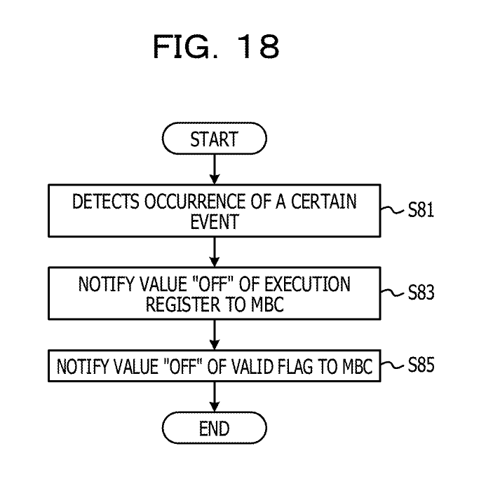

FIG. 18 illustrates another example of the process performed by the service processor. In FIG. 18, a process executed by the service processor 1000 which has detected an occurrence of a certain event is illustrated.

The processing unit 1011 detects that a certain event has occurred (Operation S81 of FIG. 18). The certain event may include, for example, a component replacement, an instruction to disconnect a power supply of the information processing apparatus 1, an instruction to stop monitoring or the like.

The processing unit 1011 notifies the MBC 110 of the system board 100 of the value of the execution register 133, for example, “OFF” (Operation S83). Accordingly, the buffer management unit 112 of the MBC 110 receives the value of the execution register 133 from the processing unit 1011 and stores the value in the execution register 133.

The processing unit 1011 notifies the MBC 110 of the system board 100 of the value of the VALID flag, for example, “OFF” and the identification information of the component related to the event (Operation S85). Accordingly, the buffer management unit 112 of the MBC 110 receives the value of the VALID flag and the identification information of the component related to the event from the processing unit 1011 and stores the value of the VALID flag in an area of the command I/F area 121 relevant for the component related to the event. The process is ended. It may be possible to reduce the retransmission of an interrupt signal for the component related to the event.

By the process as described above, monitoring may be stopped appropriately in accordance with the occurrence of the event.

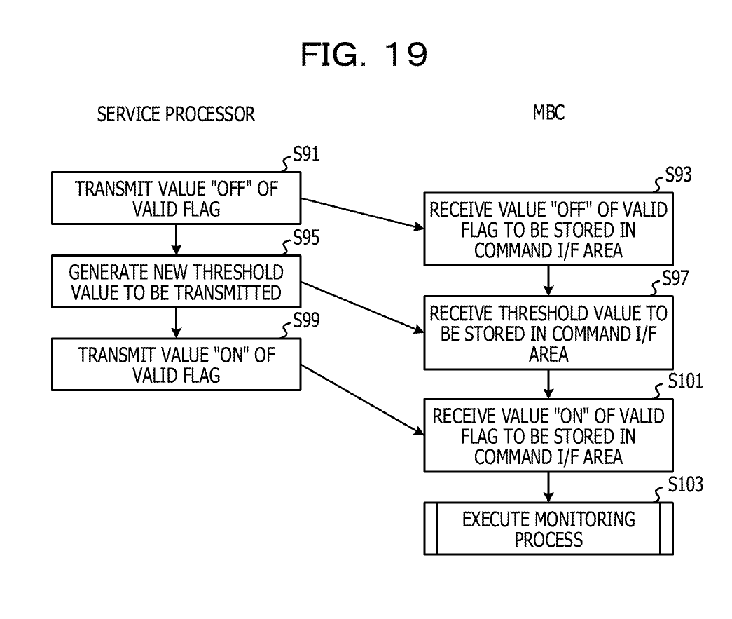

FIG. 19 illustrates an example of a process performed by the service processor and the MBC. In FIG. 19, a process executed by the service processor 1000 and the MBC 110 when a threshold value relevant for a certain component is changed is illustrated.

The manager of the information processing apparatus 1 may perform a setting of increasing the number of revolutions of the cooling fan in accordance with, for example, an increase of an outside air temperature.

Accordingly, the processing unit 1011 of the service processor 1000 notifies the MBC 110 of the system board 100 of the value of the VALID flag, for example, “OFF” and the identification information of the component, for example, the cooling fan (Operation S91 of FIG. 19). Accordingly, the buffer management unit 112 of the MBC 110 receives the value of the VALID flag and the identification information of the component and stores the value of the VALID flag in an area of the command I/F area 121 relevant for a target component, for example, a cooling fan (Operation S93).

The processing unit 1011 generates a new threshold value according to the setting after being changed. When the number of revolutions of, for example, the cooling fan is changed from 1000 rpm (revolution per minute) to 1500 rpm, the upper limit threshold value is changed from 1100 rpm to 1600 rpm and the lower limit threshold value is changed from 900 rpm to 1400 rpm. The processing unit 1011 notifies the MBC 110 of the system board 100 of the new threshold value (Operation S95). Accordingly, the buffer management unit 112 of the MBC 110 receives the threshold value and stores the threshold value in an area of the command I/F area 121 relevant for a target component, for example, a cooling fan (Operation S97).

After a certain time elapses, the processing unit 1011 notifies the MBC 110 of the system board 100 of the value of the VALID flag, for example, “ON” and the identification information of the component, for example, the cooling fan (Operation S99). Accordingly, the buffer management unit 112 of the MBC 110 receives the value of the VALID flag and the identification information of the component and stores the value of the VALID flag in an area of the command I/F area 121 relevant for a target component, for example, a cooling fan (Operation S101).

The execution control unit 111 of the MBC 110 executes a monitoring process (Operation S103). The monitoring process may be the monitoring process illustrated in FIG. 15 and FIG. 16.

When settings of, for example, hardware are changed by the process as described above, the threshold value for an abnormality detection may be dynamically changed and thus, the monitoring may be continued appropriately.

The configuration of the functional block of, for example, the service processor 1000 may not be coincident with the configuration of a program module.

Also, in a processing flow, a processing sequence may be changed and a parallel execution may be performed as long as the processing result is not changed.

When a secondary failure occurs, the process described above may be executed after the component which results in a failure is specified by employing, for example, a well-known art. The replacement of a component which is originally not in a failure state may be reduced.

The information processing apparatus includes a processor, a module, and a controller. The processor transmits a condition for detecting the abnormality of the module to the controller. The controller acquires information from the module and determines whether the information acquired from the module satisfies the condition. When the information acquired from the module satisfies the condition, the controller transmits the information indicating that the abnormality of the module is detected to the processor.

A notifying to the processor is performed only when the abnormality is detected. Further, the controller executes a simple processing suitable for the controller. The processing load of the processor is reduced and thus, a high speed processing may be achieved in the entire processing.

The information processing apparatus may also include a storage device. The controller stores the information acquired from the module in the storage device. When the information indicating that the abnormality of the module is detected is received from the controller, the processor reads the information, which is acquired from the module, from the storage device and determines whether the information acquired from the module satisfies the condition. When the information acquired from the module satisfies the condition, a processing to cope with the abnormality of the module may be executed. It may be confirmed whether there is an error in the abnormality detected by the controller. Since the processor confirms only the abnormality detected by the controller, an increase in the processing load of the processor may be reduced.

When the information acquired from the module satisfies the condition, the processor transmits a first request requesting to stop monitoring of the module to the controller. When the first request is received from the processor, the controller may stop the monitoring of the module. Notifying of the detection of the abnormality of the module to the processor several times may be reduced.

The processor transmits the first request requesting to stop monitoring of the module and a second request requesting to change the condition to a second condition for detecting the abnormality of the module to the controller. When the first request and second request are received from the processor, the controller may stop monitoring of the module and change the condition to the second condition. Detecting the abnormality which does not need to be detected due to a condition change may be reduced.

The controller may transmit information indicating that the abnormality of the module is detected to the processor by an interrupt. The processor may rapidly start the process.

The processor transmits a condition for detecting the abnormality of the module to controller which monitors the abnormality of the module. The controller acquires information from the module and determines whether the information acquired from the module satisfies the condition. When the information acquired from the module satisfies the condition, the controller transmits, to the processor, information indicating that the abnormality of the module is detected.

A program for causing the processor to perform the process described above may be created. The program may be stored in a computer-readable storage medium, such as for example, a flexible disk, a CD-ROM, a magneto-optical disk, a semiconductor memory, and a hard disk, or a storage device. An intermediate processing result may be temporarily stored in a storage device, for example, a main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a processor;
a module; and
a controller,
wherein the processor is configured to transmit a first condition for detecting an abnormality of the module to the controller, and
the controller is configured to:
acquire a first information from the module;
determine whether the first information satisfies the first condition; and
transmit a second information indicating that the abnormality of the module is detected to the processor when the first information satisfies the first condition.

2. The information processing apparatus according to claim 1, wherein the first condition includes one or more commands, a threshold value, information indicating a type of an object to be compared, and information indicating whether the determination is to be performed.

3. The information processing apparatus according to claim 1, wherein the controller is configured to sequentially execute the one or more commands to acquire the first information from the module when the one or more commands are included in the first condition.

4. The information processing apparatus according to claim 1, further comprising: a storage device configured to store the first information,
Wherein, when the second information is received from the controller, the processor is configured to read the first information from the storage device, determine whether the first information satisfies the first condition, and execute a processing for coping with the abnormality of the module when the first information satisfies the first condition.

5. The information processing apparatus according to claim 1, wherein the processor is configured to transmit a first request requesting to stop monitoring of the module to the controller when the first information satisfies the first condition.

6. The information processing apparatus according to claim 1, wherein the processor is configured to transmit a first request requesting to stop monitoring of the module and a second request requesting to change the first condition to a second condition for detecting the abnormality of the module to the controller.

7. The information processing apparatus according to claim 6, wherein the controller is configured to stop monitoring of the module and change the first condition to the second condition when the first request and the second request are received from the processor.

8. The information processing apparatus according to claim 1, wherein the controller is configured to transmit the second information to the processor by an interrupt.

9. An information processing system comprising:
a first information processing apparatus; and
a second information processing apparatus,
wherein the first information processing apparatus is configured to transmit a first condition for detecting an abnormality of a module within the information processing system to the second information processing apparatus, and
the second information processing apparatus is configured to:
acquire a first information from the module,
determine whether the first information satisfies the first condition; and
transmit information indicating that the abnormality of the module is detected to the first information processing apparatus when the first information satisfies the first condition.

10. The information processing system according to claim 9, wherein the first condition includes one or more commands, a threshold value, information indicating a type of an object to be compared, and information indicating whether the determination is to be performed.

11. The information processing system according to claim 9, wherein the second information processing apparatus is configured to sequentially execute the one or more commands to acquire the first information from the module when the one or more commands are included in the first condition.

12. The information processing system according to claim 9, wherein the first information processing apparatus includes a storage device configured to store the first information, the first information processing apparatus is configured to read the first information from the storage device when receiving the second information, determine whether the first information satisfies the first condition, and execute a processing for coping with the abnormality of the module when the first information satisfies the first condition.

13. The information processing system according to claim 9, wherein the first information processing apparatus is configured to transmit a first request requesting to stop monitoring of the module to the second information processing apparatus when the first information satisfies the first condition.

14. The information processing system according to claim 9, wherein the first information processing apparatus is configured to transmit a first request requesting to stop monitoring of the module and a second request requesting to change the first condition to a second condition for detecting the abnormality of the module to the second information processing apparatus.

15. A monitoring method comprising:
transmitting, by a processor, a first condition for detecting an abnormality of a module to a controller;
acquiring, by the controller, a first information from the module;
determining, by the controller, whether the first information satisfies the first condition; and
transmitting, by the controller, a second information indicating that the abnormality of the module is detected to the processor when the first information satisfies the first condition.

16. The monitoring method according to claim 15, wherein the first condition includes one or more commands, a threshold value, information indicating a type of an object to be compared, and information indicating whether the determination is to be performed.

17. The monitoring method according to claim 15, wherein the one or more commands are sequentially executed to acquire the first information from the module when the one or more commands are included in the first condition.

18. The monitoring method according to claim 15, further comprising:
reading the first information from a storage device configured to store the first information when receiving the second information; and
executing a processing for coping with the abnormality of the module when the first information satisfies the first condition.

19. The monitoring method according to claim 15, further comprising:
transmitting a first request requesting to stop monitoring of the module to the controller when the first information satisfies the first condition.

20. The monitoring method according to claim 15, further comprising:
transmitting a first request requesting to stop monitoring of the module and a second request requesting to change the first condition to a second condition for detecting the abnormality of the module to the controller.
